(19) United States
(12) Patent Application Publication
(10) Pub. No.: US 2019/0191747 A1
(43) Pub. Date: Jun. 27, 2019

(54) Multi-grain pasta

(71) Applicant: Obshchestvo s ogranichennoj otvetstvennostyu "Obedinenie "Soyuzpishcheprom", Chelyabinsk (RU)

(72) Inventor: Aleksandr Pavlovich BERESTOV, Chelyabinsk (RU)

(73) Assignee: Obshchestvo s ogranichennoj otvetstvennostyu "Obedinenie "Soyuzpishcheprom", Chelyabinsk (RU)

(21) Appl. No.: 16/104,556

(22) Filed: Aug. 17, 2018

(30) Foreign Application Priority Data
Dec. 25, 2017 (RU) 2017145535

(51) Int. Cl. A23L 7/113

(52) U.S. Cl. CPC A23L 7/113; A23V 2002/00

(57) ABSTRACT

The proposed product—pasta—relates to the food industry. In an embodiment, the pasta has a certain dry weight with no added water, and includes 70% of the dry weight being durum wheat flour, and 20-30% of the dry weight being whole multi-grain flour consisting of non-wheat cereals, including oat and barley. In another embodiment, the non-wheat cereals further include rye, with a resultant weight ratio of 40% of oat, 30% of barley, and 30% of rye. There is disclosed a process that allows creating multi-grain pasta, rich in nutrients and providing high contents of dietary fibers, micro- and macro-elements.

### CROSS-REFERENCES TO RELATED APPLICATIONS

This application claims priority under 35 U.S.C. 119 (a) through (d), under the Paris Convention, from a Russian Federation patent application RU2017145535 filed 25 Dec. 2017 hereby entirely incorporated by reference.

### FIELD OF THE INVENTION

The invention relates to the food industry, in particular, to the production of pasta.

### BACKGROUND OF THE INVENTION

In the production of pasta, semolina (granular flour) from durum wheat is typically used as the main raw material. Pasta made of durum wheat contains a lot of carbohydrates: 100 g of pasta contain 70 g of carbohydrates, the carbohydrates come from fiber and slowly digestible starch. These carbohydrates are digested for a long time, allowing you to keep a sense of fullness. With this digestion of carbohydrates, blood glucose varies gradually and not in leaps and bounds. It is jumps of glucose which cause the feeling of hunger. Pasta made of durum wheat is rich in protein and also contains vitamins and minerals. But food and biological value of such pasta is not high. In the production of macaroni semolina, the most part of hull (bran) is removed, which leads to a decrease in dietary fiber and micronutrients.

To improve the food and biological value of pasta, namely to increase the content of amino acids, vitamins, minerals and dietary fiber, different ingredients, both grain and non-grain, are added in raw material.

Thus, the method of pasta production (patent RU 2166863) is known, providing for kneading dough from flour, liquid and enriching supplements, shaping and drying. As an enriching supplement, a mixture with artichoke powder and iodized salt in the ratio (9.9-98.5): (1.5-90.9) pts. wt. is used, while the enriching supplement is added in quantity of 0.1-20% of the weight of flour.

The dough composition for the production of pasta (patent RU 2289952) containing wheat flour and water is known, while it additionally contains protein-based supplements (flour of leguminous crops, namely, pea flour in the amount of 10% of the wheat flour weight or lentil flour in the amount of 10% of the wheat flour weight, or a complex supplement consisting of bean flour in the amount of 2.5% of the wheat flour weight and rowanberry puree in the amount of 7.5% of the wheat flour weight), while the content of crude gluten in the wheat flour should not be below 28%.

It is known that there is a method for pasta production (patent RU 2358453), providing for the use of a mixture of baker's top-grade wheat flour and oat flour produced by grinding whole oat grains, in the ratio of 60:40-50:50 with cold-type dough kneading with water at a temperature 25° C. and dough humidity equal to 37-38%. This method also includes pasta dough kneading, its pressing, cutting of process semi-finished product to obtain the semi-finished pasta, cutting, blowing, drying, stabilization of semi-finished pasta and cooling of pasta.

Pasta made with this method, containing a mixture of baker's top-grade wheat flour and oat flour produced by grinding whole oat grains, in the ratio of 60:40-50:50, is the closest to the inventive solution herein called a “prototype”.

### OBJECT AND BRIEF DESCRIPTION OF THE INVENTION

The problem to be solved by the invention is to create multi-grain pasta with a decrease in its composition of wheat component and its replacement for whole multi-grain flour.

The problem is solved by the present invention by means of creation of pasta with enhanced nutritional and biological value and high organoleptic properties. Another result of the invention is expanding the range of pasta products.

### DETAIL DESCRIPTION OF PREFERRED EMBODIMENTS OF THE INVENTION

While the invention may be susceptible to embodiment in different forms, there are described in detail herein below, specific embodiments of the present invention, with the understanding that the instant disclosure is to be considered an exemplification of the principles of the invention, and is not intended to limit the invention to that as described herein.

According to a preferred embodiment of the invention, dry pasta is to contain about (in weight %): 70% of durum wheat flour and 20-30% of whole multi-grain flour of non-wheat cereals of the total dry flour weight, with no added water, while the non-wheat cereals are oat and barley.

According to another preferred embodiment of the invention: rye is used, as an additional non-wheat cereal, while the mixture of non-wheat cereals consists of (in weight %): the oat content in is about 40%, barley about 30%, rye about 30%.

Pasta may contain, As an additional ingredient, powdered flax seed in the amount of 5-10% (in weight %).

Oat is provided in the form of an unpolished core without shell. Barley is provided in the form of an unpolished core, partially without shell. Rye is provided in the form of a core, partially without bran and seed covering.

Use of whole multi-grain flour of non-wheat cereals, particularly oats and barley, in pasta, contributes to the increase of content of nutrients useful for the human body: dietary fiber (increased by 60%), micro- and macronutrients (magnesium, increased by 127%; phosphorus, increased by 81%; iron, increased by 53%; B1, increased by 41%; B2, increased by 55%), as well as the increase of the biological value of the product (lysine, increased by 37%; methionine and cysteine, increased by 16%).

Functional properties of dietary fibers are mainly connected with the gastrointestinal tract function. Fiber-enriched food has a positive effect on the digestive processes and, consequently, reduces the risk of diseases associated with these processes.

Soluble and insoluble fibers increase a sense of fullness, since fiber-enriched food requires longer time for chewing and digesting, thus causing greater salivation and secretion of gastric juice. Satiety prevents excessive food intake associated with obesity.

It is found that soluble fibers affect cholesterol exchange in the body, metabolites of which are fatty acids. One possible explanation of cholesterol decrease is that the soluble fibers contribute to the extraction of bile acids and increase their elimination from the body.

Vitamins and minerals are involved in metabolism and strengthen the immune system of the human body.

Proteins are most important for a human's life activities. They are the structural base of all body cells and provide for their activities. In the human body, proteins are formed from food proteins that are split as a result of digestion into amino acids, absorbed into the blood stream and used by the cells. So, lysine is associated with the process of blood formation, leucine and isoleucine are essential to the proper functioning of the thyroid gland; phenylalanine is essential for thyroid and adrenal glands; methionine affects lipid exchange, provides for antitoxic function of the liver and plays a major role in functioning of the nervous system.

The increase of limiting essential amino acids in the multi-grain pasta helps increasing their biological value compared to pasta made of macaroni top-grade flour of durum wheat.

The above indicated percentage of each type of cereal in the total weight of non-wheat cereals (oat about 40%, barley about 30%, rye about 30%) allows for balancing the pasta protein based on its amino acid composition, and increasing the dietary fiber content up to 60%.

Adding of rye to the composition increases the first limiting amino acid lysine (since rye contains 0.40% of lysine, which is 2 times more than in macaroni top-grade flour of durum wheat), dietary fiber (3.6 times more), minerals (phosphorus, potassium, magnesium, iron, calcium), and vitamins (B1, B2).

Macaroni flour (flour of durum wheat) used in the composition contains vegetable protein gluten which provides bridging property and elasticity during the dough processing, and also contributes to the formation of optimum structure of pasta with a nice familiar taste.

The content of durum wheat flour at about 70% of the total flour weight ensures optimal flavor and structure of pasta without changing the basic production parameters.

Introduction of powdered flax seed to the pasta composition ensures that the pasta contains Omega 3 and Omega 6 fatty acids, which are not synthesized in the body; flax also contains lignans, which have antioxidant properties; being rich with fiber (high-fiber), flax allows for better regulation of digestion; and flax is also a source of B vitamins and minerals (selenium, potassium, magnesium, phosphorus, iron and others).

Pasta can contain whole soft wheat flour not more than 10, which leads to an increase of dietary fiber content and nutrients in the final product.

The following is an EXAMPLE illustrating the present invention.

For the production of multi-grain pasta, a mixture of cereals is used, consisting of: oats, barley, and rye. Oat is an unpolished core without shell. Barley is an unpolished core partially without shell. Rye is a core partially without bran and seed covering.

In a preferred embodiment of the invention, the content (weight %) of oat in the mixture is about 40%, barley is about 30%, rye is about 30%.

Oat, barley and rye are fed from accumulating silos via screw dozers on a mixing screw, undergo magnetic cleaning from metal foreign matters and transferred to a bunker via a pumping pneumatic transporting line.

Next, the mixture of cereals is transferred to a processing line of multi-grain flour production, which includes four break and two fine reduction systems. The mixture of cereals is milled to the desired grinding coarseness and sifted through a sieve. The so obtained finished multi-grain flour shall contain no more than 2% of particles larger than 450 μm.

The resultant multi-grain flour consisting of whole grain components of oat, barley and rye is fed into the silos of a bulk storage warehouse. Next, the multi-grain flour, through the dosing screws, is fed to the mixing screw, to which macaroni flour of durum wheat is also fed from the silo with the following grinding coarseness: residue on sieve 450 μm is not more than 0.3%, the residue on sieve 390 μm is not more than 5%, undersize 125 μm is not more than 30±5%. The content of the flour of durum wheat accounts for about 70% of the total dry weight composition of flour in the absence of added water, and whole multi-grain flour content is about 30%.

The whole mixture undergoes magnetic cleaning, is sifted and fed into the pasta production line. The mixture obtained in a mixing kneader is mixed with purified water in a ratio of approximately 1:3, with a water content of not more than 35%. The optimal water temperature, when mixing the mixture with water, is 35-40° C. This enables optimal water absorbing capacity of flour and even moisture distribution in the flour. Mixing occurs gradually, but briefly (for about 20 seconds): at first, by sparing-type elements of the mixing kneaders with a gradual compaction and mixing by kneading elements of double-screw mixers. During mixing heat release occurs due to the friction of screws and dough, internal friction of the dough when mixing the layers, and dough friction on the mixer chamber body. As a result of the intensive mixing, the dough is obtained in the form of a loose mass of wet nubbles at a temperature of closed and sealed mixing chambers of 30-40° C.

Next, the dough undergoes the stage of compaction. A press screw removes excess air mixture by vacuuming for better compaction and pressing of the dough, for further obtaining the required regular shapes of pasta, as well as to exclude the deterioration of color and integrity of finished pasta. The dough temperature at the pressing stage is 45-50° C. The dough is compacted on the pressing heads and passes through the matrices with compacting pressure of 80-100 bar. The temperature of the pressing head is also 45-50° C. that improves plasticity and reduces the internal temperature tension of the dough. The matrix through which pasta is pressed passes about 10-20% of the dough weight pumped to it by the pressing screw; as a result, the dough is compacted, and converts into a binding compact dough mass.

The accelerated process of mixing and pressing is insured by equipment leak resistance, interconnection of the equipment elements and the observance of required temperatures.

The drying process has several stages and takes approximately 3-4 hours. The primary drying allows consolidating the external shell of raw products and the product's shape, to prevent them from losing their external appearance in the drying process. The main drying zone allows for quick takeoff of moisture with loss of water share in pasta up to 16-18%. The final dryer having a stabilization zone brings into action the mechanism of gentle moisture loss with less intensive degree of drying, in terms of temperature and humidity, with additional steam humidification, for uniformed drying of finished pasta with a humidity up to 12-12.5%. The last step in the production of pasta is cooling of the finished pasta to a temperature of storing and packaging up to 28-29° C. Then the pasta is ready for packaging.

Examples of dry pasta compositions and the influence of non-wheat cereals upon contents of dietary fiber and amino acids are shown in the TABLE below:

Examples of dry pasta compositions and the influence of non-wheat cereals on the contents of
dietary fiber and amino acids

| Ingredient | Example 1 | Example 2 | Example 3 | Example 4 | Example 5 |
|---|---|---|---|---|---|
| Oat, % wt | 12 | 20 | 7.5 | 12 | 10 |
| Barley, % wt | 9 | 10 | 7.5 | 9 | 10 |
| Rye, % wt | 9 | — | 7.5 | — | 5 |
| Crushed wheat made from | — | — | 7.5 | 9 | |
| soft wheat, % wt | | | | | |
| Flax, % wt | | | | | 5 |
| Flour of durum wheat, % wt | 70 | 70 | 70 | 70 | 70 |
| Content of dietary fibers, % | 6.0 (20) | 5.3 (18) | 6.0 (20) | 5.5 (18) | 6.5 (22) |
| (% of daily average) | | | | | |
| Percentage of content increase | | | | | |
| of: | | | | | |
| dietary fibers; | 60 | 42 | 60 | 49 | 75 |
| limiting amino acids: | 37 | 37 | 28 | 28 | 43 |
| lysine; | | | | | |
| methionine + cystine, | 16 | 28 | 10 | 16 | 14 |
| in comparison to pasta made | | | | | |
| of macaroni flour of top-grade | | | | | |
| durum wheat | | | | | |
| Percent of content increase of | | | | | |
| (% of nutrient daily average in | | | | | |
| multi-grain pasta): | | | | | |
| vitamin B1; | 41 (17.0) | 44 (17.4) | 40 (17.0) | 41 (17.1) | 75 (21.3) |
| vitamin B2; | 55 (3.9) | 45 (3.6) | 62 (4.0) | 55 (3.9) | 56 (3.9) |
| vitamin PP (niacin | 13 (16.3) | 16 (16.8) | 22 (17.7) | 27 (18.4) | 12 (16.2) |
| equivalent); | | | | | |
| potassium; | 48 (5.2) | 43 (5.0) | 47 (5.1) | 42 (4.9) | 68 (5.9) |
| magnesium | 127 (9.1) | 146 (9.9) | 127 (9.1) | 138 (9.5) | 220 (12.8) |
| phosphorus; | 81 (19.5) | 91 (20.5) | 82 (19.6) | 90 (20.4) | 103 (21.8) |
| iron; | 53 (13.1) | 50 (12.9) | 61 (13.8) | 58 (13.5) | 58 (13.6) |
| calcium, | 74 (3.1) | 86 (3.3) | 64 (3.0) | 72 (3.1) | 133 (4.2) |
| in comparison to pasta made | | | | | |
| of macaroni flour of top-grade | | | | | |
| durum wheat | | | | | |

Thus, the use of whole multi-grain flour of non-wheat cereals in pasta contributes to the increase of content of nutrients useful for the body: dietary fibers, micro- and macronutrients as well as increase of the biological value of the product (details are presented in the table).

The proposed multi-grain pasta contains a relative large amount of non-wheat components, is rich in nutrients, and provides a high content of dietary fibers, micro- and macroelements, i.e. it has increased food and biological value. The resulting product has a good structure and high organoleptic properties. In addition, multi-grain pasta expands assortment of macaroni products available in the industry.

1. Pasta characterized with a total dry flour weight with no added water; said pasta comprises:
70% of the total dry flour weight representing a durum wheat flour fraction; and
20-30% of the total dry flour weight representing a whole multi-grain flour fraction consisting of non-wheat cereals;
wherein said non-wheat cereals include oat and barley.

2. Pasta according to claim 1, wherein said non-wheat cereals further include rye.

3. Pasta according to claim 2, wherein said non-wheat cereals are a mixture substantially containing (in weight %): 40% of oat, 30% of barley, and 30% of rye.

4. Pasta according to claim 1, further comprising powdered flax seed in an amount 5-10% of the total dry flour weight.
